(19) United States
(12) Patent Application Publication
(10) Pub. No.: US 2021/0003286 A1
(43) Pub. Date: Jan. 7, 2021

(54) Digital Mantelpiece

(71) Applicant: James Gloger, Snook, TX (US)

(72) Inventor: James Gloger, Snook, TX (US)

(21) Appl. No.: 17/030,311

(22) Filed: Sep. 23, 2020

Related U.S. Application Data
(63) Continuation-in-part of application No. 15/213,682, filed on Jul. 19, 2016, now abandoned.
(60) Provisional application No. 62/322,224, filed on Apr. 13, 2016.

(51) Int. Cl. F24B 1/198; A47G 1/06

(52) U.S. Cl. CPC F24B 1/198; G06F 3/147; G09G 2380/16; A47G 1/0616

(57) ABSTRACT

A digital mantel for changeable art and photo displays. The digital mantel may include at least one screen, a power source, and a remote. The displays are structured and arranged to display digital pictures and artwork as desired by a user. The screens may include digital memory, useful for storing digital pictures and artwork for future display. The remote may include selectors, useful for accessing the digital memory. The screens may be accessed via a door in the mantel.

### CROSS REFERENCE TO RELATED APPLICATION

The present application is related to and claims priority from U.S. application Ser. No. 15/213,682 filed on Jul. 19, 2016, pending, which is related to and claims priority to prior provisional application Ser. No. 62/322,224, filed Apr. 13, 2016, which applications are incorporated herein by reference.

### BACKGROUND

The following includes information that may be useful in understanding the present invention. It is not an admission that any of the information provided herein is prior art, or material, to the presently described or claimed inventions, or that any publication or document that is expressly or implicitly referenced is prior art.

### DESCRIPTION OF RELATED ART

Many people like to hang or display art and pictures around their home. Almost every home has an area where family photos and mementos such as children's art projects and drawings are displayed. As families grow and change, and as children make more art, the space for display runs out. The older items must be removed to make room for the new.

Paper-based photographs are becoming less and less common in the digital age, and photographs of children's art projects are increasingly shared digitally. But with this increased sharing comes a display problem: nowhere to permanently store and view the photographs and artwork over time. Additionally, people are always looking for new and inventive ways to decorate their favorite spaces. A suitable solution is desired.

Several attempts have been made to solve the problems mentioned above, such as those found in U.S. Pat. No. 6,975,308 to Bitetto, et al.; U.S. Pat. No. 7,934,299 to Holzman; U.S. Pat. No. 6,849,320 to Duffney; U.S. Pat. No. 7,168,175 to Cook; 2014/0282071 to Trachtenberg, et al.; 2007/0204859 to Little, et al.; and 2005/0193613 to Faltesek. This art is representative of changeable art and photo displays.

Preferably, changeable art and photo displays should provide a customizable digital viewing platform and operate reliably. And they should be manufacturable at a modest cost. Thus, a need exists for a reliable digital mantelpiece to avoid the problems mentioned above.

### BRIEF SUMMARY

The digital mantelpiece may comprise a mantel, screen, attacher, a power source, and a remote. The mantel is structured and arranged to power the screen to display digital pictures and artwork, as desired by a user.

The screen may comprise digital memory, useful for storing digital pictures and artwork for future display. The digital memory of the screen can be connected in series with a second screen. The door may comprise hinges, useful for opening the door to access display device. Further, the door can be placed in an open condition, useful for accessing the screen's digital memory.

The digital mantelpiece's power source may comprise a 110/120 volt alternating current plug, useful for accessing electrical power in a home environment. Further, the remote may comprise selectors, useful for accessing digital memory.

A method of using a digital mantelpiece may comprise the steps of powering on a digital mantelpiece; installing digital pictures and artwork to the digital memory, removably affixing the digital mantelpiece to a vertical planar surface (wall) using hardware; and viewing the digital pictures and artwork.

### BRIEF DESCRIPTION OF THE DRAWINGS

The figures that accompany the written portion of this specification illustrate exemplars and method of use for the present invention, a digital mantelpiece, constructed and used according to the present invention's teachings.

FIG. 1 shows a perspective view of a digital mantelpiece.

FIG. 2 is a front perspective view of the digital mantelpiece of FIG. 1.

FIG. 3 is an exploded view illustrating the digital mantelpieces of FIGS. 1-2.

FIG. 4 is a schematic diagram of the display device.

FIG. 5 is a flowchart illustrating a method of use for a digital mantelpiece.

### DETAILED DESCRIPTION

As discussed above, exemplars of the present invention relate to changeable art and photo displays combined with a mantel or fireplace mantel. For instance, a digital mantelpiece could display a slideshow of pictures customized by the user.

A mantel, mantelpiece, or chimneypiece provides a frame around a real or artificial fireplace
that provides a horizontal display region 3-7 feet above the floor;
that has a back flush with the front of the associated fireplace within 1 to 12 inches;
   or
is a mostly decorative vestigial mantelpiece, decorative structure, or architectural detail reminiscent or evocative of a mantelpiece or chimneypiece.

A display or display device 400 is an output device for visually presenting information. Various digital mantelpiece exemplars aesthetically incorporate displays into mantels or fireplace mantels. Digital mantelpieces allow people to display pictures and art at a central location in their homes. These devices can replace single-framed pictures that clutter shelves and mantels and alleviate the hassle of hanging pictures and art on walls.

Digital mantelpiece 110 transforms regular mantels into digital pieces of art. This device may comprise mantel-type furniture fabricated from wood, medium-density fiberboard, or other suitable material. The mantels or fireplace mantels contain digital displays arranged for viewing. And the user controls how and what will be displayed. Even a single display can showcase numerous pieces of art, eliminating the need for separate picture frames. Mantels may also be retrofitted with digital displays to modernize them.

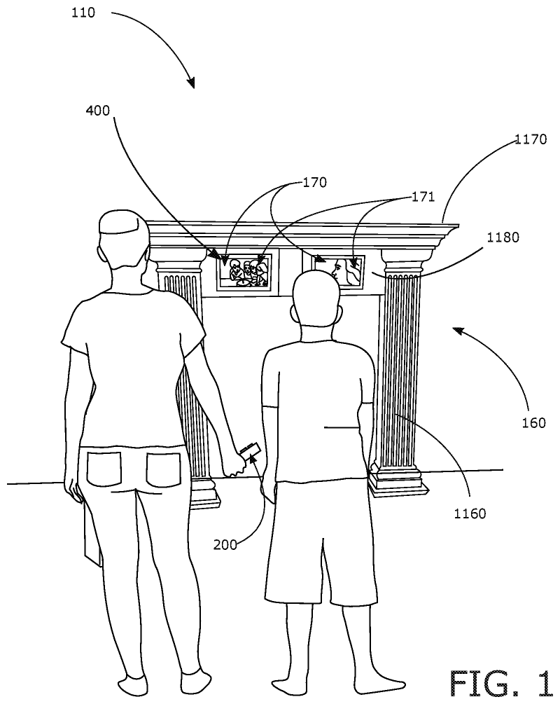

FIG. 1 shows a digital mantelpiece 110 during an ‘in-use’ condition where the user may view digital pictures and artwork 171. Digital mantelpiece 110 may comprise mantel 160, display device 400 (having a screen) 170, mount 180, power source 190, and remote 200. Mantel 160 mounts display device 400, which displays digital pictures and artwork 171 as desired by user.

Mantel 160 comprises columns 1160 and entablature 1170. Entablature 1170 comprises frieze 1180. And frieze 1180 of mantel 160 mounts displace device 400 into door opening 1190.

In some versions, digital mantelpiece 110 supports display device 400 as an operable door or in an operable door 162. Door 162, whether being display device 400 or containing display device 400 has two positions a close position, the operational position, and an open position, the maintenance position,

in which the hidden parts of the display device 400 can be accessed or service. A removable digital memory 172, such as a digital memory card, becomes accessible in some versions when door 162 is in the open position.

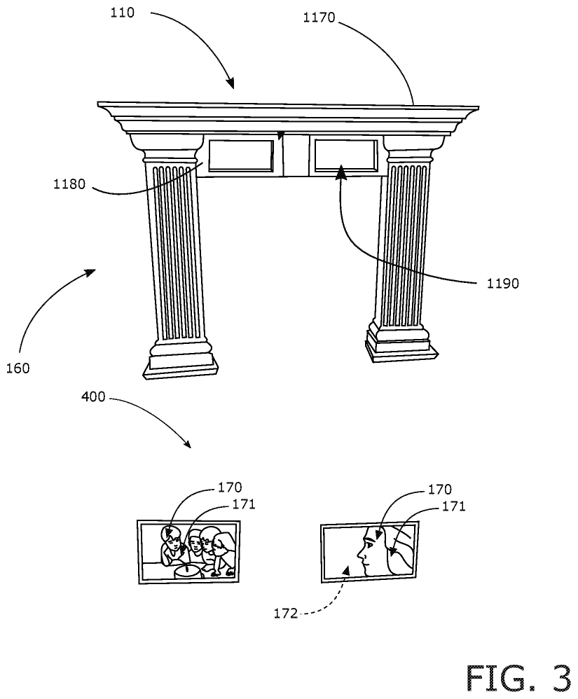

Mantel 160 may comprise interior 161 (FIG. 3) and door 162 (FIG. 3). Display device 400 may comprise a processor 410, connected to external communications module 430, memory 440, and screen 170. In some cases, memory 440 is digital memory 172, configured to store digital pictures and artwork 171 for future display. Digital memory 172 and screen 170 can be connected in series with a second screen 170.

In alternative exemplars, processor 410 may have the ability to manipulate external communications module 430, such as wireless internet communication capability 175, useful for transferring digital pictures and artwork 171 to digital memory 172. And processor 410 may also connect to a hard drive that replaces memory 440 or works with memory 440.

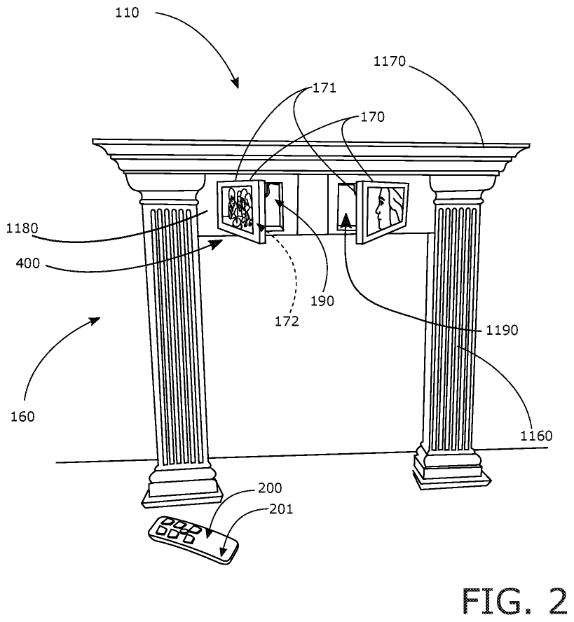

Referring now to FIG. 2, a front perspective view of a digital mantelpiece 110 is shown. Digital mantelpiece 110 may comprise mantel 160, screen 170, mount 180, power source 190, and remote 200. Further, remote 200 may comprise selectors 201, useful for accessing digital memory 172.

Continuing to refer to FIG. 2 digital mantelpiece 110 is powered by power source 190, which can be a battery (disposable, rechargeable, supercapacitor, or any other self-contained electrical storage) or power source 190 is powered from a wall outlet or hardwired, in some exemplars. In alternative exemplars of the present invention, power source 190 may comprise direct current battery power, useful for a cordless operating environment. Further, power source 190 may comprise rechargeable direct current battery power, useful for providing a reusable energy source.

The digital mantelpiece 110 may be manufactured and provided for sale in a wide variety of sizes and shapes for a wide assortment of applications.

FIG. 3 is an exploded view of digital mantelpiece 110. Mantel 160 may comprise interior 161, door 162, and decorative moldings 163. Interior 161 may further comprise depth, useful for accommodating screen 170. Interior 161 may comprise a cuboid shape, useful for storing screen 170. Screen 170 may comprise digital memory 172, useful for storing digital pictures and artwork 171 for future display. Digital memory 172 may comprise a removable flash memory card 173. Digital memory 172 may comprise a hard disk drive 174. Further, digital memory 172 of screen 170 can be connected in series with a second screen 170.

In continuing to refer to FIG. 3, door 162 may comprise hinges 220. Hinges 220 allow door 162 to open to access interior 161. Door 162 can be placed in an open condition 221, useful for accessing digital memory 172 of display device 400

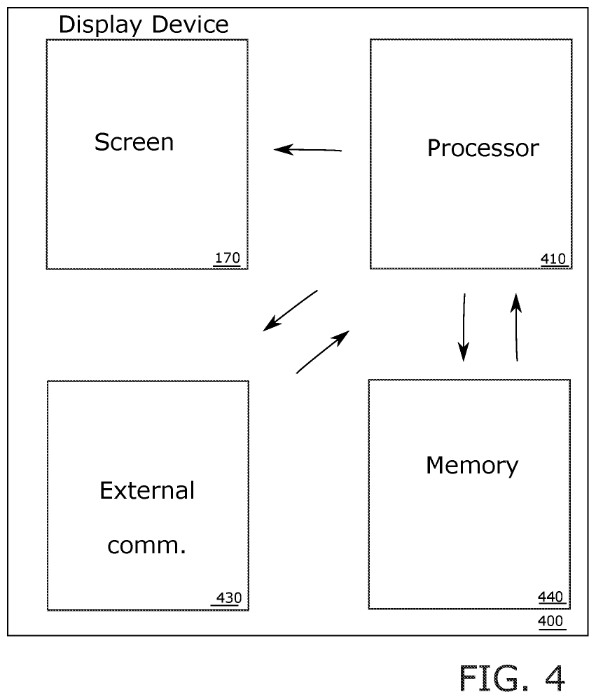

FIG. 4 shows a block diagram illustrating the connectivity of the display device 400. As illustrated, processor 410 connects to external communications 430, memory 440, and screen 170.

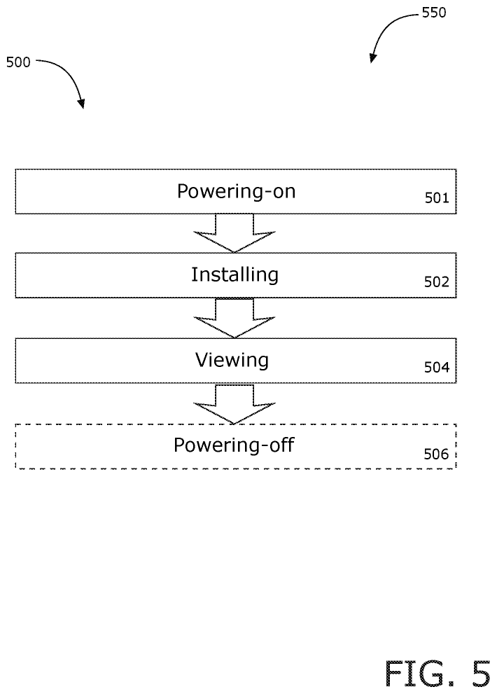

FIG. 5 shows flowchart 550 illustrating a method of use 500 for digital mantelpieces 110. As shown, method of use 500 may comprise step one 501, powering on a digital mantelpiece 110; step two 502, installing digital pictures and artwork 171 (FIG. 1) to digital memory 172 (FIG. 2) of digital mantelpiece 110 (FIG. 1); step four 504, viewing digital pictures and artwork 171 (FIG. 1)

It should be noted that step 506 is optional and may not be implemented in all cases. Optional steps of the method of use 500 are illustrated using dotted lines in FIG. 5 to distinguish them from the other steps of the method of use 500.

It should be noted that the steps described in the method of use can be carried out in many different orders according to user preference.

Entablature is a horizontal part that rests on the columns and consists of an architrave, a frieze, and a cornice. The frieze is the part of an entablature between the architrave and the cornice.

What is claimed is:

1. A mantelpiece comprising:
columns;
and
a lintel positioned above the columns
wherein the lintel has a frieze comprising a door opening and a display device mounted in a door or as a door on the opening;
wherein the display device comprises
a processor;
a screen connected to the processor;
an external communications module connected to the processor;
graphics-file memory connected to the processor;
and
a power source connected to the processor, the screen, the communications module, and the memory.

2. The mantelpiece of claim 1, wherein the display device has a closed operational position and an open maintenance position.

3. The mantelpiece of claim 2, wherein the display device further comprises a removable memory card slot.

4. The mantelpiece of claim 3 wherein the slot is accessible when the display device is in the maintenance position.

5. The mantelpiece of claim 4 wherein the graphics-file memory is a removable memory card.

6. The mantelpiece of claim 5, wherein the external communication module provides signal connectivity through a wire or wirelessly to a source of graphics files.

7. The mantelpiece of claim 6, comprising two or more display devices.

8. The mantelpiece of claim 6, wherein the display device further comprises a second screen.

9. The mantelpiece of claim 8, wherein the power source connects to a battery or a domestic electrical service.

10. The mantelpiece of claim 9, wherein the display device further comprises a remote control configured to send instructions to the processor.

11. The mantelpiece of claim 10, wherein the operational position is lockable.

12. The mantelpiece of claim 4 wherein the graphics-file memory connects to the slot.

13. The mantelpiece of claim 12, wherein the external communication module provides signal connectivity through a wire or wirelessly to a source of graphics files.

14. The mantelpiece of claim 13, wherein the display device further comprises a second screen.

15. The mantelpiece of claim 14, wherein the power source connects to a battery or a domestic electrical service.

16. The mantelpiece of claim 15, wherein the display device further comprises a remote control configured to send instructions to the processor.

17. The mantelpiece of claim 16, wherein the operational position is lockable.

18. The mantelpiece of claim 3, wherein the graphics-file memory is a hard disk drive.

19. A mantelpiece comprising:
columns;
and
a lintel positioned above the columns
wherein the lintel has a frieze comprising two door openings and two components mounted in a door or as a door on the opening;
wherein at least one component has a closed, lockable operational position and an open maintenance position;
wherein the display device comprises
a processor;
a screen connected to the processor;
an external communications module connected to the processor that provides signal connectivity through a wire or wirelessly to a source of graphics files;
a removable memory card slot accessible when the display device is in the maintenance position;
graphics-file memory connected to the processor wherein the graphics-file memory is a removable memory card, connects to the slot, is a hard disk drive, or connects to a hard disk drive;
a power source, powered by a connection to a battery or a domestic electrical service, and connected to the processor, the screen, the communications module, and the memory;
a remote control configured to send instructions to the processor;
and
wherein the components are the screens of a display device with two screens or are two display devices.

20. A method of using a mantelpiece comprising:
powering-on a display device contained in a mantelpiece;
installing digital pictures and artwork to digital memory of the display device;
and
viewing the digital pictures and artwork.
